(19) United States
(12) Patent Application Publication
(10) Pub. No.: US 2026/0045128 A1
(43) Pub. Date: Feb. 12, 2026

(54) EXTENDED READING MODULE FOR AN ACCESS CONTROL SYSTEM, ACCESS CONTROL SYSTEM WITH THE EXTENDED READING MODULE AND METHOD

(71) Applicant: Robert Bosch GmbH, Stuttgart (DE)

(72) Inventors: Jannik van der Smissen, Aachen (DE); Julia Steinacker, Sachsenheim (DE); Max Bluecher, Aachen (DE); Ulrich Pinsdorf, Aachen (DE)

(21) Appl. No.: 19/294,525

(22) Filed: Aug. 8, 2025

(30) Foreign Application Priority Data
Aug. 9, 2024 (DE) 10 2024 207 622.8

(51) Int. Cl. G07C 9/00; G07C 9/27

(52) U.S. Cl. CPC G07C 9/00309; G07C 9/27

(57) ABSTRACT

An extended reading module for an access control system with a radio interface for reading an access identifier from a mobile terminal device, with an access control device interface for connection to an access control device, wherein the access control device interface is configured to accept a device data packet based on an access identifier from the access control device, with a system interface for transmitting a module data packet within the access control system, wherein the extended reading module is configured to provide and transmit the module data packet based on the access identifier or the device data packet.

### BACKGROUND

The invention relates to an extended reading module for an access control system, an access control system and a method for access control.

Buildings, production areas or other sections are often protected by access controls. The access controls are protected by technical apparatuses or systems that monitor and control access to certain areas, buildings or resources. The access controls are used to ensure that only authorized persons are granted access.

For example, electronic card readers for RFID cards, magnetic stripe cards or smart cards, biometric systems with fingerprint scanners, facial recognition, cell phones, iris or retina scanners, or PIN codes with keypad entry of personal identification numbers are used for identification.

Patent application DE 10 2021 207 700 A1 describes a modular access control system that supports various identification technologies such as biometric methods, RFID cards, PIN codes, and mobile devices. The system enables multi-factor authentication to increase security. A central management platform allows easy configuration and real-time monitoring of all access events. It also offers interfaces to other security systems such as video surveillance and alarm systems. The system can be used in a variety of applications, such as corporate buildings, data centers and residential complexes, and offers flexible and customizable solutions for different security requirements.

### SUMMARY

An extended reading module having the features of the disclosure, an access control system, and a method are proposed. Preferred or advantageous embodiments of the invention are shown in the disclosure, the following description and the attached Figures.

Subject matter of the invention is an extended reading module which is suitable and/or configured for an access control system. In particular, the extended reading module is configured as an electronic module.

The extended reading module has a radio interface for reading an access identifier from a mobile terminal device. The mobile terminal device is configured in particular as a smartphone, cell phone, wearable or the like. An app is preferably arranged to run on the mobile terminal device in order to enable the access identifier to be read out.

The access identifier is configured in particular as a sequence of digits. Preferably, the access identifier is limited to the use of digits. Optionally, the access identifier may comprise letters and/or special characters. The access identifier is unique and/or exclusive identification information, which is assigned to an employee or user by the access control system, for example. In particular, the access identifier is only present once in the access control system. Alternatively or additionally, the access identifier can be referred to as ‘metadata’, which is not used for the actual assignment of a person, but supports the infrastructure (technical, logical, logistical).

The extended reading module has an access control device interface that is suitable and/or configured for connection to an access control device.

The access control device may in particular comprise a card reader for accepting a or the access identifier, a keyboard for accepting a or the access identifier, a biometric recognition device for recognizing the user and for assigning a or the access identifier to the recognized user. In particular, the access control device may comprise any technology that enables a or the access identifier of a user to be determined directly or indirectly.

The access control device interface is configured to accept a device data packet, which is based on the detected access identifier, from the access control device. The device data packet is thus available at the access control device interface. The access control device interface is configured in particular as a cable interface.

The data packet, in particular the device data packet or also further data packets within the disclosure, comprises the access identifier, in particular in an unencrypted form. This means that the access identifier can be taken directly from the data packet without decoding. Preferably, the data packet has no recipient and/or sender address. In this case, the path of the data packet is determined by the structure of the network and/or of the cabling.

The extended reading module has a system interface which is suitable and/or configured for the transmission of a module data packet in the access control system. In particular, the module data packet is configured as a data packet as described above. In particular, the module data packet is configured in the same way as the device data packet. The system interface is configured in particular to send and/or output the module data packet. In particular, the system interface is configured as a cable interface.

The extended reading module is configured to provide and transmit the module data packet on the basis of the read-out access identifier or the device data packet.

It is a consideration of the invention that new or already integrated access control devices do not have a radio interface. On the other hand, mobile terminal devices are increasingly being used as identification means in access control systems. The extended reading module makes it possible to technically extend the access control device and to add the function of reading an access identifier from a mobile terminal device. In this way, new access control devices can be modernized with the extended reading module or existing access control devices—in the sense of retro-fit - can be easily and cost-effectively upgraded with this function.

Here, the extended reading module relies on an intervention in the access control system, which can also be referred to as ‘man-in-the-middle’technology, wherein the extended reading module is arranged serially in terms of data between the access control device and the further access control system, in particular at the controller. Alternatively, the architecture can be referred to as serial chaining, daisy-chaining, interposition, mediator, interposing, queuing, etc. In the event that an access identifier is acquired via the access control device, this access identifier is passed on as a module data packet. In the event that an access identifier is detected via the radio interface and thus the extended reading module, this access identifier is passed on as a module data packet. This creates a smart way of extending the access control system and in particular the access control device to include the function of reading an access identifier from a mobile terminal device.

In a preferred implementation, the extended reading module is configured to forward the device data packet unchanged or possibly signal-technically improved as a module data packet. In this case, the device data packet is looped through the extended reading module and forwarded as a module data packet. Alternatively, the device data packet is read out by the extended reading module and the module data packet is recreated on the basis of the device data packet. Both variants lead to the same technical result, but differ only in the technical implementation.

In a preferred further development, the access control device interface is configured to accept a presence signal from the access control device. Such presence signals are used to report the functionality or presence of the access control device in the access control system. The extended reading module is configured to provide and transmit a or the presence signals at the system interface. In this way, optionally either the presence signal from the access control device is looped through or the presence signal from the access control device is detected and/or read out by the extended reading module, is regenerated and output again. The last alternative has the advantage that it may be provided that the presence signal is only output if both the presence signal from the access control device is present and the extended reading module is in an operational state.

In particular, it is provided that the access control device interface and the system interface are configured to use the same communication protocol. This ensures that the access control system, in particular the controller, cannot distinguish whether the module data packet was generated by the access control device or by the extended reading module.

In a preferred implementation, the communication protocol is configured as a Wiegand protocol. The Wiegand protocol is a widely used communication standard for data exchange between access control devices, in particular card readers, and such access control systems. It is based on two data lines, Data0 and Data1, which transmit binary data in the form of pulses. A signal on Data0 represents a ‘0 ’bit, while a signal on Data1 represents a ‘1 ’bit. For example, the pulses are achieved by pulling the level down to low (0V). This means that in the idle state, both levels are high (often 5V). If a 1 is transmitted, D1 briefly goes low; if a 0 is transmitted, D0 briefly goes low. These signals are voltage changes that are generated by the access control device and/or the extended reading module and are recognized by the access control system, in particular the controller.

The preferred Wiegand format consists of 26 bits: 8 bits for the facility code, 16 bits for an ID and 2 parity bits for error detection. However, there are also variants with 34, 37 or more bits that can transmit more data. Transmission is asynchronous and serial, which means that the bits are sent one after the other without the need for synchronous clocking. The combination of the facility code and the ID form the access identifier. The access identifier may—also with a bit number of e.g. more than 20 bits, in particular with the bit number mentioned before or after—have a different meaning in terms of content, for example all bits only form the ID as access identifier.

One advantage of the Wiegand protocol is its robustness and reliability, in particular in safety-critical applications such as the present access control system. It is insensitive to electromagnetic interference, which makes it ideal for use in environments with high levels of electrical noise. It is also relatively easy to implement and does not require complex hardware components. Due to these characteristics, the Wiegand protocol has been a standard in access control technology for decades and is used in a wide range of applications, from simple door openers to complex security systems in companies and public authorities. Its widespread use and support by numerous manufacturers make it a durable and proven technology. It is therefore particularly advantageous that the extended reading module can supplement new or existing access control devices.

In a preferred realization, the radio interface is configured as an NFC apparatus, Bluetooth apparatus, in particular BLE apparatus, and/or as a UWB apparatus.

The NFC interface (Near Field Communication) enables wireless communication over short distances of around 4 centimeters. It is often used in smartphones, credit cards and access control systems. NFC operates at a frequency of 13.56 MHz and enables fast and secure data exchange between devices by simply approaching or tapping them.

The Bluetooth or BLE interface enables wireless communication over short to medium distances, typically up to 100 meters. In the present case, reading from the extended reading module is only possible if the distance is short, in particular less than 50 cm, especially less than 10 cm.

The UWB interface (Ultra-Wideband) enables high-precision wireless communication over short distances with an accuracy of a few centimeters. UWB uses an extremely broad frequency spectrum of several gigahertz and transmits very short pulses that last only a fraction of a nanosecond. This technology offers a high data transmission rate and is ideal for real-time location, precise position determination and the transmission of large amounts of data in a short time. With UWB technology, it is particularly easy to ensure that the mobile terminal device is in the immediate vicinity of the extended reading module.

In a preferred further development, the extended reading module is configured to read the access identifier from the mobile terminal device via the radio interface on the basis of a certificate structure. Particularly preferably, the extended reading module has a private and a public key, which form a key pair in a PKI structure. The PKI structure (Public Key Infrastructure) is a system of guidelines, processes, procedures and components for managing, securing and distributing digital certificates and public keys. It is used to ensure the security of electronic communications and transactions by providing mechanisms for the secure creation, management, verification and revocation of certificates. In a preferred first step, the public key is transferred from the mobile terminal device to the extended reading module. The extended reading module is configured to check and validate the public key using its own public key. A challenge message is then sent from the extended reading module to the mobile terminal device. The mobile terminal device signs the challenge message and sends the signed challenge message back to the extended reading module. This checks the signature with the previously transmitted and validated public key of the mobile terminal device. If the check is positive, the extended reading module takes the access identifier from the previously transmitted and validated public key of the mobile terminal device.

In terms of construction, it is preferable that the extended reading module is configured as an independent installation unit. This may, for example, be arranged in a flush-mounted box or in some other way between the access control device and the access control system, in particular the controller. In this way, retrofitting (retro-fit) of the access control device is particularly easy. Alternatively, the extended reading module may be integrated into existing access control devices as an independent module, wherein the extended reading module is connected to the access control device via the access control device interface, so that the use of the extended reading module is independent of the hardware/software equipment of the access control device.

Optionally, it may be provided that the extended reading module is reset to factory settings by short-circuiting the device interfaces of the radio interface and/or the access control device interface.

A further subject matter of the invention is formed by an access control system which is suitable and/or configured for access control of a building, a production area, a factory plant, an office building, etc.

The access control system has the access control device as described above. The access control device is configured to detect the access identifier and to provide the device data packet.

Furthermore, the access control system has the extended reading module, as described above. In addition, the access control system comprises the controller, as described above, for accepting the module data packet. The controller has a plurality of communication interfaces, wherein one of the communication interfaces is directly connected to the extended reading module and indirectly connected to the access control device via the extended reading module. The communication interfaces also form the addresses of the connected components. In this way, the network is greatly simplified, since the data packet does not have to or does not have any sender and/or receiver addresses, since the sender and receiver are defined via the communication interface and the cable connection.

The controller is connected to the access control device via interconnection of the extended reading module using data technology and/or signal technology via two data lines for transmitting the access identifier in the form of the data packet. In particular, the two data lines correspond to the Data0 and Data1 data lines as defined in the Wiegand protocol.

The controller can forward the access identifiers within the access control system for further processing, wherein the access control system controls an actuator, such as a door opener or the like. Alternatively, the controller controls the actuator directly.

Optionally, the controller is connected to the access control device via at least one signal line for transmitting an access signal and/or sound control signal, optionally with the extended reading module being interconnected, bypassed or connected in parallel. Preferably at least two, preferably exactly three signal lines are provided, wherein one of the signal lines transmits a positive access signal, wherein the positive access signal activates a green LED in the access control device, for example, wherein one of the signal lines transmits a negative access signal, wherein the negative access signal activates a red LED in the access control device, for example, wherein one of the signal lines transmits an audio control signal, wherein the audio control signal activates a buzzer or another acoustic output device. In the event that the access identifier is valid and the actuator is controlled, the positive access signal and the sound control signal are transmitted; in the event that the access identifier is not valid, the negative access signal is transmitted. All or only some of the signal lines may be carried out by the extended reading module. Alternatively, the extended reading module and the access control device are connected in parallel with the signal lines or a selection thereof. In this case, the extended reading module has a feedback signal which may be transmitted to the mobile terminal device via the radio interface, for example. Alternatively, the signal lines bypass the extended reading module and are only connected to the access control device. In this case, the integration and implementation of the extended reading module is simplified, since only the data lines need to be connected to the extended reading module.

In a preferred further development, the access control system has a plurality of extended reading modules, wherein the extended reading modules are arranged between the access control device and the controller in terms of signal technology. In particular, the extended reading modules are arranged in series. In this way, any number of radio interfaces may be provided for reading an access identifier from a mobile terminal device, which may be spaced apart from each other. In particular, two or more of the extended reading modules may be connected in series on the same data lines (with or without a reader). This achieves a logical or-interconnection of the extended reading modules and thus of the radio interfaces. If any extended reading module generates a module data packet, it is routed through all other extended reading modules to the controller. This would make it possible to install in particular BLE readers as extended reading modules that are spatially distributed but logically all control the same door or unit. One application would be, for example, two curved/aircases/driveways that lead to the same door on the right and left. Or an underground parking garage entrance that has a car lane and a bicycle lane leading to the same roller shutter door. It may be spatially advantageous to install a separate extended reading module for the cyclist and the car driver.

Readers for physical cards are used in a similar way at barriers, e.g. at factory entrances or toll booths. Two readers are often installed at different heights so that reader 1 (e.g. at a height of 1.20 m) can be easily reached by a car driver and reader 2 (at a height of 2.50 m) by a truck driver. Both open the same barrier. This arrangement may be simulated by using several extended reading modules and may be supplemented in particular as a retro-fit.

A further subject matter of the invention relates to a method for access control, in particular for operating the access control system as previously described, wherein the access control system is first provided.

At a first arbitrary point in time, the access control device detects an access identifier. The access control device forms a device data packet and sends this to the extended reading module. The extended reading module forwards the device data packet to the controller as a module data packet. Alternatively, the extended reading module generates the module data packet on the basis of the device data packet. The controller is configured to create an authorization for an access and in particular to directly and/or indirectly control an actuator, for example a door opener, a turnstile, an automatic door or the like.

At a second arbitrary point in time, the extended reading module reads an access identifier from the mobile terminal device. The module data packet is generated on the basis of the access identifier and is forwarded to the controller.

At both points in time, the controller is configured to create an authorization for access and, in particular, to directly and/or indirectly control an actuator, for example a door opener, a turnstile, an automatic door or similar.

A hardware module has thus been developed that uses the standardized interface between the reader/access control device and the door controller and is therefore independent of the reader/access control device hardware. The extended reading module may be placed between the reader/access control device and the door controller (like a ‘man-in-the-middle’) and provides mobile access services without interfering with the reader/access control device itself. The form factor may vary from a standalone device that connects to existing Wiegand wiring to a module that is part of a third-party product. On a commercial level, this idea offers numerous possibilities, ranging from being sold as a standalone device for retrofit scenarios, to being offered as a retrofit module for reading/vice/access control devices from any vendor, to being sold to reading/vice/access control device vendors for integration of the extended reading module into their reading/vice/access control device.

All that is needed is a ‘receiver’for radio data, e.g. mobile-access BLE data, which also understands Wiegand, translates it into Wiegand in particular and may send it. This mobile access capability does not have to be integrated into the electronics of the access control device. Therefore, the form factor is preferably selected so that the extended reading module may be hidden behind the access control device or in a flush-mounted box. The extended reading module is connected to the existing cabling of the access control device. It acts as a ‘man in the middle’ on the power and data connections of the access control device. There are therefore two Wiegand transmitters (normal access control device+extended reading module) that are connected to the controller and transmit (and receive) via the same wires.

### BRIEF DESCRIPTION OF THE DRAWINGS

Further features, advantages and effects of the invention are apparent from the following description of preferred configuration examples of the invention and the accompanying Figures. These show:

FIG. 1 shows a block diagram of an access control system as a configuration example of the invention;

FIG. 2 shows a detailed representation of the access control system for a first alternative;

FIG. 3 shows a detailed representation of the access control system for a second alternative.

### DETAILED DESCRIPTION

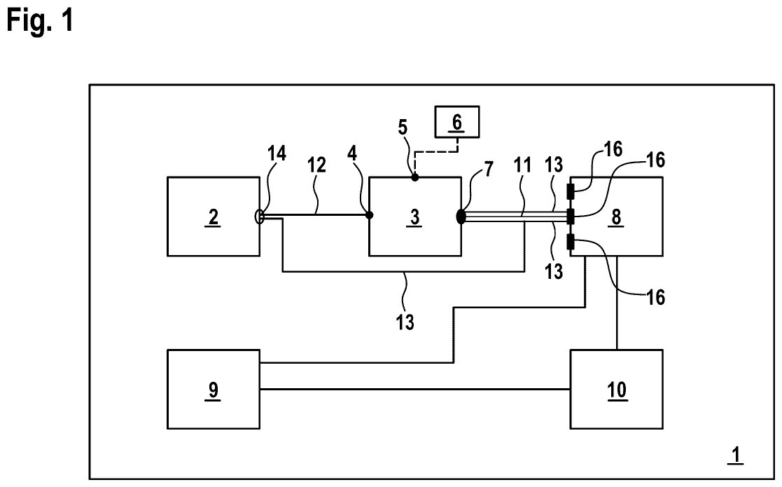

FIG. 1 shows a schematic block diagram of an access control system 1 as a configuration example of the invention. The access control system 1 is used in buildings, public authorities, factories and in other applications in order to implement access control for doors, turnstiles, etc.

The access control system 1 has one or more access control devices 2, wherein the access control device 2 is configured, for example, as a card reader for ID cards. The access control device 2 is configured to read an access identifier from the ID card in this example. Alternatively, the access control device 2 may be configured as a keypad for entering the access identifier or a pin code, which is linked to the access ID in terms of data. It is also possible for the access control device 2 to detect biometric data, wherein the biometric data is linked to the access identifier. The access identifier is provided by activating the access control device 2. The access control device 2 creates a device data packet based on the access identifier, wherein the device data packet comprises the access identifier in terms of data technology. The access control device 2 has a connection interface 14 for outputting the device data packet.

The access control system 1 has an extended reading module 3 for the access control device 2. Thus, at least one, some or all access control devices 2 may be assigned such an extended reading module 3.

The extended reading module 3 has an access control device interface 4, wherein the access control device interface 4 is configured to accept the device data packet from the access control device 2.

The extended reading module 3 has a radio interface 5, which may read a or the access identifier from a mobile terminal device 6. The radio interface 5 is configured, for example, as an NFC interface, Bluetooth interface, BLE interface and/or NFC interface. The access identifier is read out using a certificate structure, for example, so that increased security is provided. It may be provided that the radio interface 5 is only activatable for reading if it is ensured that the mobile terminal device 6 is in the immediate vicinity of the extended reading module 3 and/or the radio interface 5, i.e. at a distance of less than 20 cm, for example.

The extended reading module 3 has a system interface 7, wherein the system interface 7 is configured to output a module data packet with a or the access identifier. On the one hand, it may be provided that the module data packet corresponds to the device data packet and thus the access identifier read out by the access control device 2 is contained in the module data packet. On the other hand, it may be provided that the module data packet was created on the basis of the access ID that was read from the mobile terminal device 6.

The access control system 1 has a controller 8, wherein the controller 8 receives the module data packet and compares the access identifier with a database or the like in the access control system 1. In the event that the access identifier is valid, the controller 8 issues an authorization and controls an actuator 9, which is configured as a door opener, a turnstile, a swing door, etc., for example, so that the desired access is authorized and a user may pass through. Alternatively, the controller 8 may continue to send the access identifier, wherein the access identifier is checked, authorized and/or the actuator 9 is controlled, e.g. via a central unit 10.

In this way, the access identifier may alternatively be transmitted to the access control system 1 via the access control device 2 or the extended reading module 3.

Communication between the access control device 2 and the extended reading module 3 as well as between the extended reading module 3 and the controller 8 is wired and, in this configuration example, takes place via two data lines Data0 and Data1, which are provided with the reference sign 11 in FIG. 1. Wiegand also includes supply lines +/−. A communication protocol, such as the Wiegand protocol or a related protocol, is used for communication, wherein the access identifier is transmitted in the data packet, i.e. in the device data packet and in the module data packet, for example unencrypted as a bit sequence. The bit sequence may have a length of 24 bits, for example, or a different bit length. The access ID is assigned once in the access control system 1.

When implementing the device data packet in the extended reading module 3, it may on the one hand be provided that the device data packet is looped or passed through the extended reading module 3 and then forms the module data packet. Alternatively, the access identifier is read from the device data packet and the access identifier is inserted into a module data packet, which is then transmitted.

The controller 8 has a plurality of communication interfaces 16, wherein the extended reading module 3 and thus indirectly the access control device 2 is connected to one of the communication interfaces 16 via data lines 11. The controller 8 and/or the access control system 1 knows the identity of the access control device 2 and/or of the extended reading module 3 via the connection to the communication interface 16. This means that a sender and/or receiver address may be omitted from the device data packet and/or the module data packet, as is provided in the Wiegand protocol, for example.

In the event that there is no access identifier and/or no device data packet is transmitted, the access control device 2 transmits a presence signal via the data lines 11. The presence signal is configured, for example, as a high signal on both data lines 11. In the event that the extended reading module 3 does not have an access identifier either, the presence signal is looped through by the access control device 2. Alternatively, the presence signal is read out by the extended reading module 3 and a presence signal is generated by the extended reading module 3, which is then output via the system interface 7.

In addition to the data lines 12, the access control device 2 is directly or indirectly connected to the controller 8 and in particular to the communication interface 16 via one or more signal lines 13. One of the signal lines 13 transmits a positive access signal, wherein the positive access signal activates a green LED in the access control device 2, for example. One of the signal lines 13 transmits a negative access signal, wherein the negative access signal activates a red LED in the access control device 2, for example. One of the signal lines 13 transmits an audio control signal, wherein the audio control signal controls a buzzer or another acoustic output device in the access control device 2.

On the one hand, it may be provided that the signal lines 13 bypass the extended reading module 3 and are only connected to the access control device 2. Alternatively, it may be provided that the access control device 2 and the extended reading module 3 are connected in parallel to the signal lines 13. It is also possible for the signal lines 13 to be looped through the extended reading module 3. The last two options have the advantage that the information content of the signal lines 13 is also available to the extended reading module 3 and may, for example, be forwarded to the mobile terminal device 6 to inform the user.

Furthermore, a ground line and a power supply line may be provided as cable connections as supply lines, which may be connected in the same way to the access control device 2 and to the extended reading module 3. It is therefore possible for a first cable connection to be formed between the controller 8 and the extended reading module 3 and a second cable connection to be formed between the extended reading module 3 and the access control device 2, which comprise the data lines 11, the signal lines 13 and the supply lines. In this configuration, the extended reading module 3 is particularly easy to integrate. Alternatively, the first and second cable connections only have the data lines 11, wherein the signal lines 13 and/or the supply lines supply the access control device 2 and the extended reading module 3 in parallel as described or bypass the extended reading module 3 in terms of data and signals.

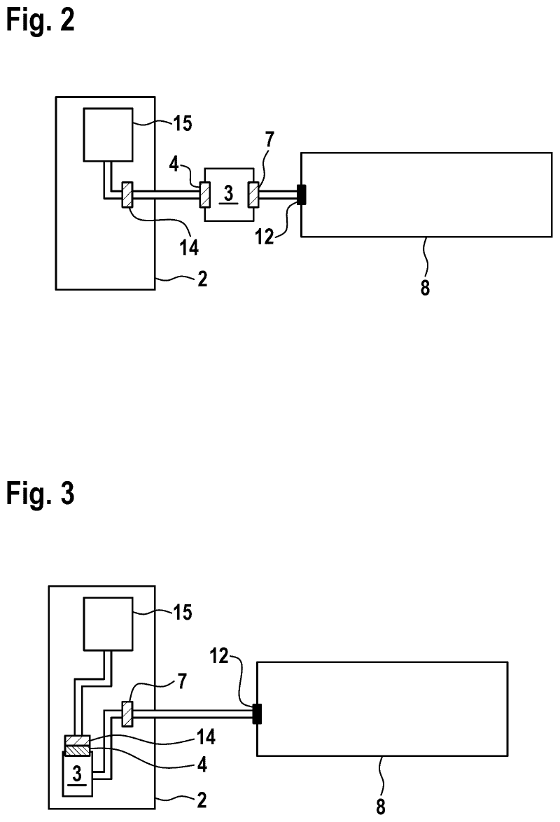

FIG. 2 shows a schematic block diagram of the access control device 2, the extended reading module 3 and the controller 8 as a further configuration example of how these may be used in the access control system 1 in FIG. 1. The access control device 2 has a microcontroller 15, which controls the access control device 2. The connection interface 14 is connected to the output of the microcontroller 15. The connection interface 14 is connected to the access control device interface 4. This means that the extended reading module 3 is first coupled to the connection interface 14, so that the extended reading module 3 may be coupled independently of the hardware or software of the access control device 2. In this configuration example, the extended reading module 3 is configured as a unit that may be easily integrated in a flush-mounted box or in another space-saving manner. The extended reading module 3 of this configuration example is particularly suitable for supplementing existing access control devices 2.

FIG. 3 shows an alternative configuration example in the same representation as FIG. 2, wherein the extended reading module 3 is integrated in the housing of the access control device 2. The access control device interface 4 and the connection interface 14 may also be configured together.

The connection interface 14 and/or the communication interface 16 are configured as Wiegand interfaces and/or Wiegand protocol compliant.

1. An extended reading module (3) for an access control system (1), the extended reading module (3) comprising:
a radio interface (5) for reading an access identifier from a mobile terminal device (6),
an access control device interface (4) for connection to an access control device (2), wherein the access control device interface (4) is configured to accept a device data packet based on an access identifier from the access control device (2), and
a system interface (7) for transmitting a module data packet within the access control system (1),
wherein the extended reading module (3) is configured to provide and transmit the module data packet based on the access identifier or the device data packet.

2. The extended reading module (3) according to claim 1, wherein the extended reading module (3) is configured to output the device data packet as the module data packet at the system interface (7) or in that the module data packet is generated based on the device data packet.

3. The extended reading module (3) according to claim 1, wherein the access control device interface (4) is configured to accept a presence signal from the access control device (2), wherein the extended reading module (3) is configured to provide and/or transmit a or the presence signal at the system interface (7).

4. The extended reading module (3) according to claim 1, wherein the access control device interface (4) and the system interface (7) are configured to use the same communication protocol.

5. The extended reading module (3) according to claim 4, wherein the protocol is configured as Wiegand protocol.

6. The extended reading module (3) according to claim 1, wherein the radio interface (5) is configured as an NFC apparatus, Bluetooth apparatus, and/or as a UWB apparatus.

7. The extended reading module (3) according to claim 1, wherein the extended reading module (3) is configured to read the access identifier via the radio interface (5) based on a certificate structure.

8. The extended reading module (3) according to claim 1, wherein the extended reading module (3) is configured as an independent installation unit.

9. An access control system (1) comprising:
an access control device (2), wherein the access control device (2) is configured to detect an access identifier and to provide a device data packet,
the extended reading module (3) according to claim 1, and
a controller (8) for accepting the module data packet.

10. The access control system (1) according to claim 9, wherein the controller (8) is connected to the access control device (2) via interconnection of the extended reading module (3) using data technology via two data lines (11) for transmitting the access identifier.

11. The access control system (1) according to claim 9, wherein the controller (8) is connected to the access control device (2) via at least one signal line (13) for transmitting an access signal and/or audio control signal, and the extended reading module (3) is interconnected, bypassed, or connected in parallel.

12. The access control system (1) according to claim 9, wherein the access control system (1) has a plurality of extended reading modules (3), wherein the extended reading modules (3) are arranged between the access control device (2) and the controller (8) in terms of signal transmission.

13. A method for access control, the method comprising:
providing an access control system (1),
detecting, at a first arbitrary point in time and via an access control device (2), an access identifier,
forming, via the access control device 2, a device data packet and sending it to an extended reading module (3), wherein the extended reading module (3) forwards the device data packet to a controller (8) as a module data packet or generates the module data packet base on the device data packet and forwards it to the controller (8), wherein the controller (8) is configured to create an authorization for an access;
reading, at a second arbitrary time, via the extended reading module (3) an access identifier from a mobile terminal device (6),
generating the module data packet based on the access identifier and forwarding it to the controller (8), wherein the controller (8) is configured to create an authorization for an access.
